(19) United States
(12) Patent Application Publication
(10) Pub. No.: US 2024/0220525 A1
(43) Pub. Date: Jul. 4, 2024

(54) SYSTEM FOR CONTEXT-BASED DATA AGGREGATION AND PRESENTMENT

(71) Applicant: BANK OF AMERICA CORPORATION, Charlotte, NC (US)

(72) Inventors: Joseph Michael Baird, Charlotte, NC (US); Lauren Marie Steinkerchner, Charlotte, NC (US); Jorge E. Camargo, Los Angeles, CA (US); Leslie Jaye Lochman, Charlotte, NC (US)

(73) Assignee: BANK OF AMERICA CORPORATION, Charlotte, NC (US)

(21) Appl. No.: 18/092,766

(22) Filed: Jan. 3, 2023

(51) Int. Cl. G06F 16/34; G06F 40/205; G06F 40/30; G06F 40/40

(52) U.S. Cl. CPC G06F 16/345; G06F 40/205; G06F 40/30; G06F 40/40

(57) ABSTRACT

Systems, computer program products, and methods are described herein for context-based data aggregation and presentment. The present disclosure is configured to receive, from a user input device, a user input triggering data aggregation and presentment from a first user interface; initiate semantic parsing of information associated with the first user interface using natural language processing algorithms; capture contextual information associated with the first user interface based on at least the semantic parsing; determine one or more sources of network data based on at least the contextual information; retrieve information from the one or more sources of network data; and display, via a second user interface, the information from the one or more sources of network data on the user input device.

### TECHNOLOGICAL FIELD

Example embodiments of the present disclosure relate to data aggregation and presentment.

### BACKGROUND

Summarization attempts to present data in a comprehensible and informative manner often results in either overloading the user with too much data in an attempt to provide all the information, or too little in an attempt to provide an abridged version.

Applicant has identified a number of deficiencies and problems associated with data aggregation and presentment. Through applied effort, ingenuity, and innovation, many of these identified problems have been solved by developing solutions that are included in embodiments of the present disclosure, many examples of which are described in detail herein

### BRIEF SUMMARY

Systems, methods, and computer program products are provided for context-based data aggregation and presentment.

In one aspect, a system for context-based data aggregation and presentment is presented. The system comprising: a processing device; a non-transitory storage device containing instructions when executed by the processing device, causes the processing device to: receive, from a user input device, a user input triggering data aggregation and presentment from a first user interface; initiate semantic parsing of information associated with the first user interface using natural language processing algorithms; capture contextual information associated with the first user interface based on at least the semantic parsing; determine one or more sources of network data based on at least the contextual information; retrieve information from the one or more sources of network data; and display, via a second user interface, the information from the one or more sources of network data on the user input device.

In some embodiments, in retrieving the information from the one or more sources of network data, the system is further configured to: initiate extractive summarization of information associated with the one or more sources of network data using the natural language processing algorithms; and generate information summaries for the information associated with the one or more sources of network data based on at least the extractive summarization.

In some embodiments, in displaying the information, the system is further configured to: generate a personalized dashboard for the user based on at least the one or more sources of network data, wherein the dashboard comprises one or more data slots for the one or more sources of network data; and display the information summaries for the information associated with the one or more sources of network data in the one or more data slots.

In some embodiments, the system is further configured to: receive, from the user input device, a user interaction input associated with a first information summary, wherein the first information summary is associated with a first data source; and generate a third user interface to be overlaid on the second user interface to display a first information associated with the first data source, wherein the first information is an unabridged version of the first information summary.

In some embodiments, the one or more sources of network data are associated with the user.

In some embodiments, the system is further configured to: receive, from the user input device, a user customization input selecting a first subset of the one or more sources of network data; and update the second user interface to display the information from the first subset of the one or more sources of network data based on at least the user customization input.

In some embodiments, the system is further configured to: deploy, using a machine learning (ML) subsystem, a trained ML model on the information from the one or more sources of network data; generate predictive analytics for the user based on at least the information from the one or more sources of network data using the trained ML model; and display the predictive analytics for the user on the second user interface.

In another aspect, a computer program product for context-based data aggregation and presentment is presented. The computer program product comprising a non-transitory computer-readable medium comprising code causing an apparatus to: receive, from a user input device, a user input triggering data aggregation and presentment from a first user interface; initiate semantic parsing of information associated with the first user interface using natural language processing algorithms; capture contextual information associated with the first user interface based on at least the semantic parsing; determine one or more sources of network data based on at least the contextual information; retrieve information from the one or more sources of network data; and display, via a second user interface, the information from the one or more sources of network data on the user input device.

In yet another aspect, a method for context-based data aggregation and presentment is presented. The method comprising: receiving, from a user input device, a user input triggering data aggregation and presentment from a first user interface; initiating semantic parsing of information associated with the first user interface using natural language processing algorithms; capturing contextual information associated with the first user interface based on at least the semantic parsing; determining one or more sources of network data based on at least the contextual information; retrieving information from the one or more sources of network data; and displaying, via a second user interface, the information from the one or more sources of network data on the user input device.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for context-based data aggregation and presentment, in accordance with an embodiment of the disclosure;

FIG. 2 illustrates a method for context-based data aggregation and presentment, in accordance with an embodiment of the disclosure.

FIG. 3 illustrates an example interface for context-based data aggregation and presentment, in accordance with an embodiment of the invention.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, an “engine” may refer to core elements of an application, or part of an application that serves as a foundation for a larger piece of software and drives the functionality of the software. In some embodiments, an engine may be self-contained, but externally-controllable code that encapsulates powerful logic designed to perform or execute a specific type of function. In one aspect, an engine may be underlying source code that establishes file hierarchy, input and output methods, and how a specific part of an application interacts or communicates with other software and/or hardware. The specific components of an engine may vary based on the needs of the specific application as part of the larger piece of software. In some embodiments, an engine may be configured to retrieve resources created in other applications, which may then be ported into the engine for use during specific operational aspects of the engine. An engine may be configurable to be implemented within any general purpose computing system. In doing so, the engine may be configured to execute source code embedded therein to control specific features of the general purpose computing system to execute specific computing operations, thereby transforming the general purpose system into a specific purpose computing system.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

The accelerating volume of sources of network data, and subsequently data, has made data science is one of the fastest growing field across multiple industries. Data science combines math and statistics, specialized programming, advanced analytics, artificial intelligence (AI), and machine learning with specific subject matter expertise to uncover actionable insights hidden in an entity's data. Broadly, a data science lifecycle includes data ingestion, data processing, data analysis, and data presentment. Entities collect data from a variety of sources, including transactions, investments, smart (IoT) devices, industrial equipment, videos, images, audio, social media and more. While machine learning (ML) techniques can be used to ingest and process this data from a macro-level, providing a condensed and accurate summary of the information, including any insight gained from the processing remains a challenge. Summarization attempts to present data in a comprehensible and informative manner often results in either overloading the user with too much data in an attempt to provide all the information, or too little in an attempt to provide an abridged version.

The present disclosure addresses this issue by identifying sources of network data based on a point of origin, and ingesting data from the identified sources of network data using context-based semantic analysis to more generate information summaries and insights. By selectively choosing sources of network data, the present disclosure captures and extracts data from the most applicable sources of network data and provides accurate insights and intelligence using efficient visualization techniques. In doing so, the present disclosure reduces the amount of computing resources, such as processing resources, storage resources, network resources, and/or the like, that are being used. In addition, the present disclosure removes manual input and waste from the implementation of the solution, thus improving speed and efficiency of the process and conserving computing resources. Furthermore, the technical solution described herein uses a rigorous, computerized process to perform specific tasks and/or activities that were not previously performed. In specific implementations, the technical solution bypasses a series of steps previously implemented, thus further conserving computing resources.

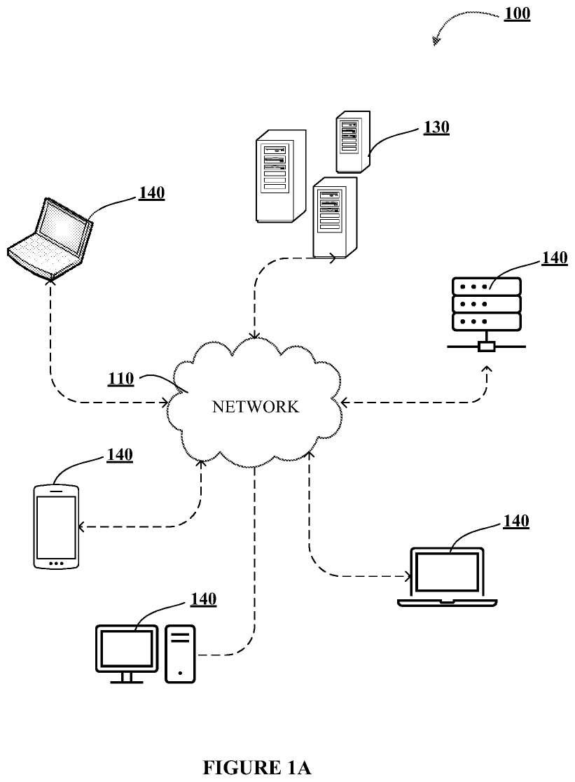

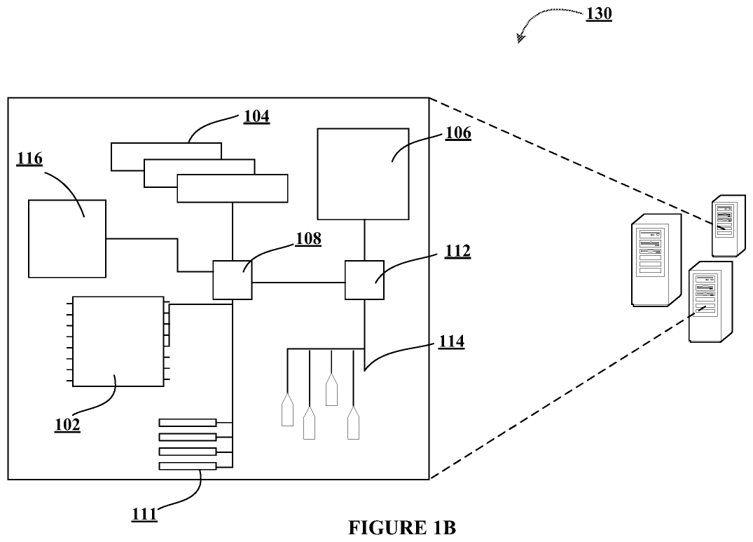

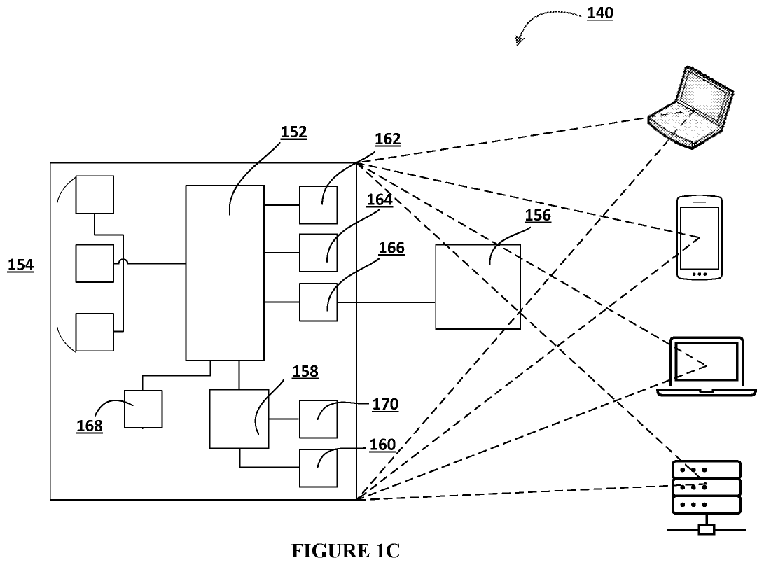

FIGS. 1A-1C illustrate technical components of an exemplary distributed computing environment for context-based data aggregation and presentment 100, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, input/output (I/O) device 116, and a storage device 110. The system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer- or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation- and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

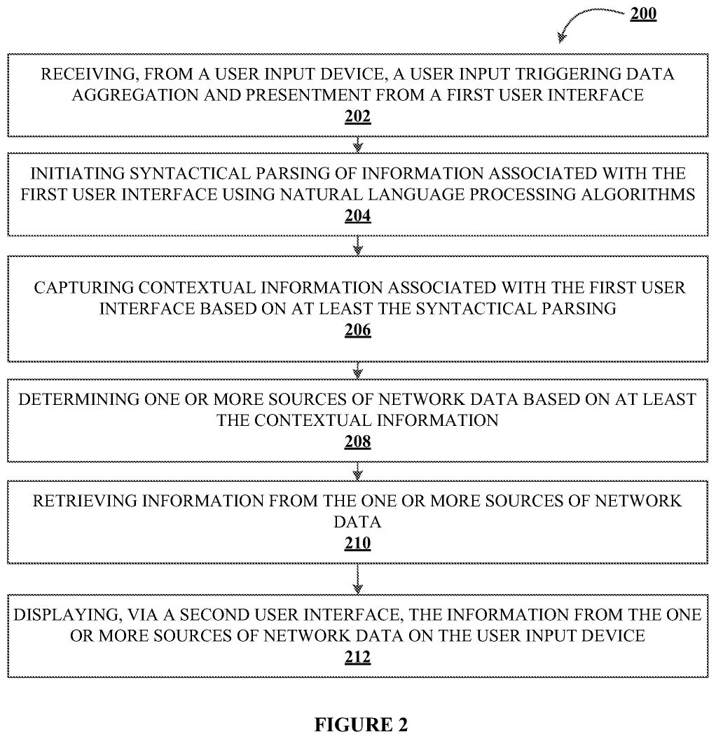

FIG. 2 illustrates a method for context-based data aggregation and presentment, in accordance with an embodiment of the disclosure. As shown in block 202, the method includes receiving, from a user input device, a user input triggering data aggregation and presentment from a first user interface. In some embodiments, the first user interface may be one of many user interfaces accessible to the user for interaction. The system may provide the user with an interaction feature, such as a swipe up to display, on the first user interface to provide the user input. In some aspect, the mere user selection of the interaction feature may be received as the user input. The user selection of the interaction feature from the first user interface may be an indication that the user wishes to generate informational summaries and insights that are based on the information presented on the first user interface. These informational summaries and insights may change depending on the user interface from which the user selects the interaction feature. In this way, the system may present the user with information that are most applicable to the user's needs at that time.

Next, as shown in block 304, the method includes initiating semantic parsing of information associated with the first user interface using natural language processing algorithms. Natural language processing combines rule-based modeling of human language with statistical, machine learning, and deep learning models to enable computers to process human language in the form of text or voice data and to ‘understand’ its full meaning, complete associated intent and sentiment. Semantic parsing may include analyzing the information associated with the first user interface with the rules of a formal grammar. To this end, the system may segment, tokenize, and assign a structure to part-of-speech tagged text that reveals the relationships between tokens governed by syntax rules. In addition, semantic parsing may be used to understand the meaning and interpretation of words, signs, and sentence structure associated with the information associated with the first user interface. In other words, semantic parsing may be used to analyze the grammatical format of sentences, including the arrangement of words, phrases, and clauses, to determine contextual information associated with independent terms from the information associated with the first user interface in a specific context. To achieve this, the system may implement natural language processing techniques such as lemmatization and stemming, topic modelling, keyword extraction, knowledge graphs, word clouds, named entity recognition, sentiment analysis, text summarization, bag of words, tokenization, and/or the like, using natural language processing algorithms such as recurrent neural networks (RNN), long-short term memory (LSTM), bidirectional, transformational, self-attention, and/or the like. It is to be understood that the foregoing list of natural language processing techniques and algorithms are merely examples and should not be construed to narrow the scope or spirit of the disclosure in any way.

Next, as shown in block 306, the method includes capturing contextual information associated with the first user interface based on at least the semantic parsing. In some embodiments, contextual information may include at least n-grams, noun phrases, themes, and facets present within the information associated with the first user interface.

Next, as shown in block 308, the method includes determining one or more sources of network data based on at least the contextual information. In some embodiments, the sources of network data may refer to one or more end-point locations where information associated with the user is currently available and/or stored. In instances where the entity is a financial institution, the user may be a customer of the entity who uses multiple services and/or products offered by the entity. For example, the user may have a checking account, a savings account, an investment account, a mortgage, a personal loan, and/or the like, with the entity. Each service and/or product may further be associated with and/or depend on external data (e.g., market data) that may be used by the user to determine the user's next steps in managing the services and/or product. For users who utilize the full slate of services and/or products offered by the entity, presenting all the information associated with the services and/or products, additional information (e.g., market data) that can possibly affect the services and/or products, insights associated with possible next steps, and/or the like, in an accurate and concise manner can become cumbersome.

By identifying specific sources of network data based on information associated with the first user interface, the system may focus on analyzing the most accurate information for presentment. For example, if the user selects the interactive feature from an accounts summary page, the system may capture contextual information that may indicate that the user wishes to view a summary of their accounts (e.g., mortgage account, investment account, and/or the like) with the entity. Then, the system may identify the sources of network data (e.g., points of access to data associated with various accounts of the user). In addition, the system may also identify complementing sources of network data that provide external information that may affect the performance of the user's accounts.

Next, as shown in block 310, the method includes retrieving information from the one or more sources of network data. In some embodiments, in retrieving the information from the one or more sources of network data, the system may initiate extractive summarization of information associated with the one or more sources of network data using the natural language processing algorithms. In response, the system may generate information summaries for the information associated with the one or more sources of network data based on at least the extractive summarization. For example, the information summary for an investment account of the user may include a graphical performance indicator of the user's investments, a summary of the account balance, top market factors affecting or likely to affect the user's investments, and/or the like.

Next, as shown in block 312, the method includes displaying, via a second user interface, the information from the one or more sources of network data on the user input device. In some embodiments, in displaying the information, the system may generate a personalized dashboard for the user based on at least the one or more sources of network data. In one aspect, the dashboard may include data slots for the identified sources of network data. In response, the system may display the information summaries for the information associated with the sources of network data in the data slots.

In some embodiments, the personalized dashboard is customizable. In this regard, the system may allow the user to choose specific sources of network data that the user wishes to view when selecting the interaction feature from the first user interface. Accordingly, the system may receive, from the user input device, a user customization input selecting a first subset of the sources of network data. In response, the system may update the second user interface to display the information from the first subset of the sources of network data based on at least the user customization input. In addition, the system may also allow the user to customize the position, level of detail, and display style associated with the personalized dashboard.

In some embodiments, the system may allow the user to select a particular information summary to view additional (or unabridged version) of the information associated with the source of network data. For example, if the information summary is that of an investment account, by selecting the information summary for the investment account, the user may choose to view a more detailed version of the investment portfolio. Accordingly, the system may receive, from the user input device, a user interaction input associated with a first information summary that is associated with a first data source. In response, the system may generate a third user interface to be overlaid on the second user interface to display a first information associated with the first data source. Here, the first information is an unabridged version of the first information summary.

In some embodiments, the system may deploy, using a machine learning (ML) subsystem, a trained ML model on the information from the one or more sources of network data. A trained ML model may refer to a mathematical model generated by machine learning algorithms based on training data, to make predictions or decisions without being explicitly programmed to do so. In one aspect, the system may train the ML model using historical information from the sources of network data, various insights generated based on the historical information, and likelihood of success based on the similarity between the insights generated using the historical information and the subsequent ground truth.

The ML model represents what was learned by the selected machine learning algorithm and represents the rules, numbers, and any other algorithm-specific data structures required for decision-making. Selecting the right machine learning algorithm may depend on a number of different factors, such as the problem statement and the kind of output needed, type and size of the data, the available computational time, number of features and observations in the data, and/or the like. ML algorithms may refer to programs that are configured to self-adjust and perform better as they are exposed to more data. To this extent, ML algorithms are capable of adjusting their own parameters, given feedback on previous performance in making prediction about a dataset.

The ML algorithms contemplated, described, and/or used herein include supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), and/or any other suitable machine learning model type. Each of these types of machine learning algorithms can implement any of one or more of a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial least squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and/or the like.

The ML model may be trained using repeated execution cycles of experimentation, testing, and tuning to modify the performance of the ML algorithm and refine the results in preparation for deployment of those results for consumption or decision making. The ML model may be tuned by dynamically varying hyperparameters in each iteration (e.g., number of trees in a tree-based algorithm or the value of alpha in a linear algorithm), running the algorithm on the data again, and then comparing its performance on a validation set to determine which set of hyperparameters results in the most accurate model. The accuracy of the model is the measurement used to determine which set of hyperparameters is best at identifying relationships and patterns between variables in a dataset based on the input, or training data. A fully trained ML model is one whose hyperparameters are tuned and model accuracy maximized. When deployed, the trained ML model may be used to generate predictive analytics for the user. The predictive analytics is then displayed for the user on the second user interface.

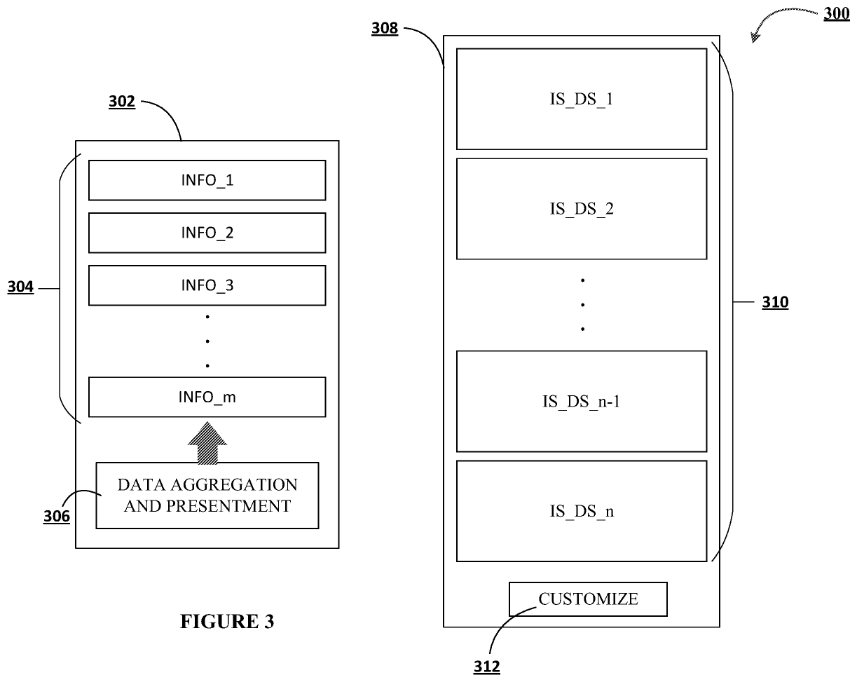

FIG. 3 illustrates an example interface for context-based data aggregation and presentment, in accordance with an embodiment of the invention. As shown in FIG. 3, the first user interface 302 may include at least information INFO_1, INFO_2, INFO_3, . . . , INFO_m 304 displayed thereon and a data aggregation and presentment 306 option (e.g., the interaction feature). The user may select the data aggregation and presentment 306 option to initiate the second user interface 308 (e.g., personalized dashboard). As described herein, the system may capture contextual information using the information INFO_1, INFO_2, INFO_3, . . . , INFO_m 304 associated with the first user interface 304 and identify sources of network data that are applicable to the information. Then, the system may access the information from the sources of network data and subsequently generate information summaries IS_DS_1, IS_DS_2, OS_DS_3, . . . , IS_DS_n 310 therefor. The information summaries IS_DS_1, IS_DS_2, OS_DS_3, . . . , IS_DS_n 310 may then be displayed as a personalized dashboard on the second user interface 308. As described herein, the personalized dashboard is customizable. Accordingly, the second user interface 310 may include a customization option 312 for the user. By selecting the customize option 312, among other customization options, the user may select specific sources of network data that the user wishes to view when selecting the data aggregation and presentment 306 from the first user interface 302.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for context-based data aggregation and presentment, the system comprising:
a processing device;
a non-transitory storage device containing instructions when executed by the processing device, causes the processing device to:
receive, from a user input device, a user input triggering data aggregation and presentment from a first user interface;
initiate semantic parsing of information associated with the first user interface using natural language processing algorithms;
capture contextual information associated with the first user interface based on at least the semantic parsing;
determine one or more sources of network data based on at least the contextual information;
retrieve information from the one or more sources of network data; and
display, via a second user interface, the information from the one or more sources of network data on the user input device.

2. The system of claim 1, wherein, in retrieving the information from the one or more sources of network data, the system is further configured to:
initiate extractive summarization of information associated with the one or more sources of network data using the natural language processing algorithms; and
generate information summaries for the information associated with the one or more sources of network data based on at least the extractive summarization.

3. The system of claim 2, wherein, in displaying the information, the system is further configured to:
generate a personalized dashboard for the user based on at least the one or more sources of network data, wherein the dashboard comprises one or more data slots for the one or more sources of network data; and
display the information summaries for the information associated with the one or more sources of network data in the one or more data slots.

4. The system of claim 3, wherein the system is further configured to:
receive, from the user input device, a user interaction input associated with a first information summary, wherein the first information summary is associated with a first data source; and
generate a third user interface to be overlaid on the second user interface to display a first information associated with the first data source, wherein the first information is an unabridged version of the first information summary.

5. The system of claim 1, wherein the one or more sources of network data are associated with the user.

6. The system of claim 1, wherein the system is further configured to:
receive, from the user input device, a user customization input selecting a first subset of the one or more sources of network data; and
update the second user interface to display the information from the first subset of the one or more sources of network data based on at least the user customization input.

7. The system of claim 1, wherein the system is further configured to:
deploy, using a machine learning (ML) subsystem, a trained ML model on the information from the one or more sources of network data;
generate predictive analytics for the user based on at least the information from the one or more sources of network data using the trained ML model; and
display the predictive analytics for the user on the second user interface.

8. A computer program product for context-based data aggregation and presentment, the computer program product comprising a non-transitory computer-readable medium comprising code causing an apparatus to:
receive, from a user input device, a user input triggering data aggregation and presentment from a first user interface;
initiate semantic parsing of information associated with the first user interface using natural language processing algorithms;
capture contextual information associated with the first user interface based on at least the semantic parsing;
determine one or more sources of network data based on at least the contextual information;
retrieve information from the one or more sources of network data; and
display, via a second user interface, the information from the one or more sources of network data on the user input device.

9. The computer program product of claim 8, wherein the code further causes the apparatus to:
initiate extractive summarization of information associated with the one or more sources of network data using the natural language processing algorithms; and
generate information summaries for the information associated with the one or more sources of network data based on at least the extractive summarization.

10. The computer program product of claim 9, wherein, in displaying the information, the code further causes the apparatus to:
generate a personalized dashboard for the user based on at least the one or more sources of network data, wherein the dashboard comprises one or more data slots for the one or more sources of network data; and
display the information summaries for the information associated with the one or more sources of network data in the one or more data slots.

11. The computer program product of claim 10, wherein the code further causes the apparatus to:
receive, from the user input device, a user interaction input associated with a first information summary, wherein the first information summary is associated with a first data source; and
generate a third user interface to be overlaid on the second user interface to display a first information associated with the first data source, wherein the first information is an unabridged version of the first information summary.

12. The computer program product of claim 8, wherein the one or more sources of network data are associated with the user.

13. The computer program product of claim 8, wherein the code further causes the apparatus to:
receive, from the user input device, a user customization input selecting a first subset of the one or more sources of network data; and
update the second user interface to display the information from the first subset of the one or more sources of network data based on at least the user customization input.

14. The computer program product of claim 8, wherein the code further causes the apparatus to:
deploy, using a machine learning (ML) subsystem, a trained ML model on the information from the one or more sources of network data;
generate predictive analytics for the user based on at least the information from the one or more sources of network data using the trained ML model; and
display the predictive analytics for the user on the second user interface.

15. A method for context-based data aggregation and presentment, the method comprising:
receiving, from a user input device, a user input triggering data aggregation and presentment from a first user interface;
initiating semantic parsing of information associated with the first user interface using natural language processing algorithms;
capturing contextual information associated with the first user interface based on at least the semantic parsing;
determining one or more sources of network data based on at least the contextual information;
retrieving information from the one or more sources of network data; and
displaying, via a second user interface, the information from the one or more sources of network data on the user input device.

16. The method of claim 15, wherein the method further comprises:
initiating extractive summarization of information associated with the one or more sources of network data using the natural language processing algorithms; and
generating information summaries for the information associated with the one or more sources of network data based on at least the extractive summarization.

17. The method of claim 16, wherein, in displaying the information, the method further comprises:
generating a personalized dashboard for the user based on at least the one or more sources of network data, wherein the dashboard comprises one or more data slots for the one or more sources of network data; and
displaying the information summaries for the information associated with the one or more sources of network data in the one or more data slots.

18. The method of claim 17, wherein the method further comprises:
receiving, from the user input device, a user interaction input associated with a first information summary, wherein the first information summary is associated with a first data source; and
generating a third user interface to be overlaid on the second user interface to display a first information associated with the first data source, wherein the first information is an unabridged version of the first information summary.

19. The method of claim 15, wherein the one or more sources of network data are associated with the user.

20. The method of claim 15, wherein the method further comprises:
receiving, from the user input device, a user customization input selecting a first subset of the one or more sources of network data; and
updating the second user interface to display the information from the first subset of the one or more sources of network data based on at least the user customization input.
